(19) United States
(12) Patent Application Publication
(10) Pub. No.: US 2025/0047397 A1
(43) Pub. Date: Feb. 6, 2025

(54) RADIO WAVE INTERFERENCE EVALUATION APPARATUS, RADIO WAVE INTERFERENCE EVALUATION METHOD, AND STORAGE MEDIUM

(71) Applicant: NEC Corporation, Minato-ku, Tokyo (JP)

(72) Inventors: Shuhei MIZUGUCHI, Tokyo (JP); Kosei KOBAYASHI, Tokyo (JP)

(73) Assignee: NEC Corporation, Minato-ku, Tokyo (JP)

(21) Appl. No.: 18/719,912

(22) PCT Filed: Dec. 28, 2021
(86) PCT No.: PCT/JP2021/048803

§ 371 Date: Jun. 14, 2024

(51) Int. Cl. H04B 17/309; H04B 17/318; H04W 64/00

(52) U.S. Cl. CPC H04B 17/346; H04B 17/328; H04W 64/003

(57) ABSTRACT

A radio wave interference evaluation apparatus includes at least one processor, the at least one processor carrying out: an obtaining process of obtaining a total received power in a predetermined frequency band measured at a point in a communication area of a target wireless communication system, a received power of a reference signal of the target wireless communication system measured at the point, and a status of radio resource usage of the target wireless communication system; and an evaluation process of evaluating radio wave interference with the target wireless communication system from outside the target wireless communication system.

### TECHNICAL FIELD

The present invention relates to a radio wave interference evaluation apparatus, a radio wave interference evaluation method, and a radio wave interference evaluation program.

### BACKGROUND ART

Recently, use of wireless communication systems has increased, and wireless communication systems superior in communication quality are required. The communication quality of wireless communication systems drops when radio wave interference occurs. Such radio wave interference includes not only radio wave interference internally arising in a wireless communication system, but also radio wave interference externally arising from outside a wireless communication system. In maintaining the communication quality of wireless communication systems, it is important to evaluate this radio wave interference from outside a wireless communication system.

Patent Literature 1 discloses an apparatus for inferring the location of an interference source of radio wave interference in a wireless communication network on the basis of the number of duplicate receptions associated with retransmission of data.

### CITATION LIST

### Patent Literature

### [Patent Literature 1]

Japanese Patent Application Publication, Tokukai, No. 2015-073242

### SUMMARY OF INVENTION

### Technical Problem

However, retransmission of data generally occurs for reasons other than radio wave interference. Thus, an example object of an example aspect of the present invention is to evaluate radio wave interference from outside a target wireless system, using radio quality information, without using the number of times of data retransmission.

### Solution to Problem

A radio wave interference evaluation apparatus in accordance with an example aspect of the present invention includes: obtaining means for obtaining a total received power in a predetermined frequency band measured at a point in a communication area of a target wireless communication system, a received power of a reference signal of the target wireless communication system measured at the point, and a status of radio resource usage of the target wireless communication system; and evaluation means for evaluating radio wave interference with the target wireless communication system from outside the target wireless communication system, with reference to the total received power, the received power of the reference signal, and the status of radio resource usage.

A radio wave interference evaluation method in accordance with an example aspect of the present invention includes: obtaining, by a computer, a total received power in a predetermined frequency band measured at a point in a communication area of a target wireless communication system, a received power of a reference signal of the target wireless communication system measured at the point, and a status of radio resource usage of the target wireless communication system; and evaluating, by the computer, radio wave interference with the target wireless communication system from outside the target wireless communication system, with reference to the total received power, the received power of the reference signal, and the status of radio resource usage.

A radio wave interference evaluation program in accordance with an example aspect of the present invention is a radio wave interference evaluation program for causing a computer to function as a radio wave interference evaluation apparatus, the program causing the computer to function as: obtaining means for obtaining a total received power in a predetermined frequency band measured at a point in a communication area of a target wireless communication system, a received power of a reference signal of the target wireless communication system measured at the point, and a status of radio resource usage of the target wireless communication system; and evaluation means for evaluating radio wave interference with the target wireless communication system from outside the target wireless communication system, with reference to the total received power, the received power of the reference signal, and the status of radio resource usage.

### Advantageous Effects of Invention

According to an example aspect of the present invention, it is possible to evaluate radio wave interference from outside a target wireless communication system, using radio quality information, without using the number of times of data retransmission.

### BRIEF DESCRIPTION OF DRAWINGS

FIG. 1 is a diagram illustrating an outline of a radio wave interference evaluation apparatus in accordance with a first example embodiment of the present invention.

FIG. 2 is a flowchart of a radio wave interference evaluation method in accordance with the first example embodiment of the present invention.

FIG. 3 is a diagram illustrating an outline of a radio wave interference evaluation apparatus in accordance with a second example embodiment of the present invention.

FIG. 4 is a diagram illustrating an environment in which the radio wave interference evaluation apparatus in accordance with the second example embodiment of the present invention is applicable.

FIG. 5 is a flowchart of a radio wave interference evaluation method in accordance with the second example embodiment of the present invention.

FIG. 6 is a diagram for describing in detail the radio wave interference evaluation method in accordance with the second example embodiment of the present invention.

FIG. 7 is a diagram illustrating an outline of a variation of the radio wave interference evaluation apparatus in accordance with the second example embodiment of the present invention.

FIG. 8 is a diagram illustrating an outline of another variation of the radio wave interference evaluation apparatus in accordance with the second example embodiment of the present invention.

FIG. 9 is a diagram illustrating an environment in which a radio wave interference evaluation apparatus in accordance with a fifth example embodiment of the present invention is applicable.

FIG. 10 is a flowchart of a radio wave interference evaluation method in accordance with the fifth example embodiment of the present invention.

FIG. 11 is a diagram for describing in detail radio wave interference of a radio wave interference evaluation apparatus in accordance with the fifth example embodiment of the present invention.

FIG. 12 is a diagram for describing in detail radio wave interference of the radio wave interference evaluation apparatus in accordance with the fifth example embodiment of the present invention.

FIG. 13 is a diagram for describing in detail a radio wave interference evaluation apparatus in accordance with a sixth example embodiment of the present invention.

FIG. 14 is a diagram illustrating an example of a computer that executes instructions of a program which is software implementing the functions of each of the radio wave interference evaluation apparatuses in accordance with the example embodiments of the present invention.

### EXAMPLE EMBODIMENTS

### First Example Embodiment

The following description will discuss a first example embodiment of the present invention in detail with reference to the drawings. The present example embodiment is a basic form of example embodiments described later.

### (Radio Wave Interference Evaluation Apparatus)

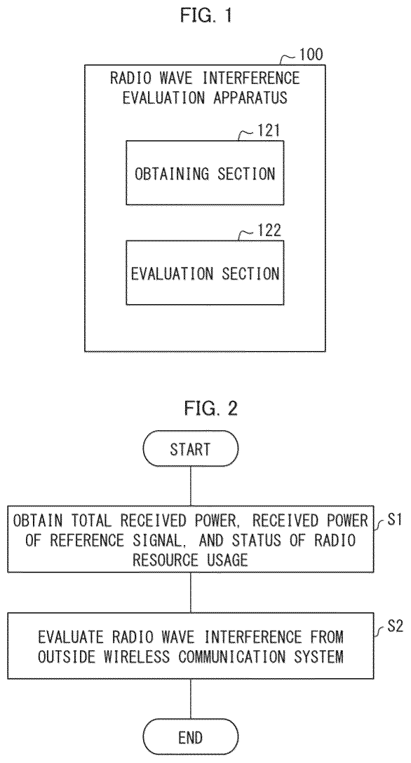

The following description will discuss the configuration of a radio wave interference evaluation apparatus 100 in accordance with the present example embodiment with reference to FIG. 1. FIG. 1 is a diagram illustrating an outline of the radio wave interference evaluation apparatus 100. The radio wave interference evaluation apparatus 100 is an apparatus for evaluating radio wave interference with a target wireless communication system from outside the target wireless communication system.

The radio wave interference to be evaluated by the radio wave interference evaluation apparatus 100 is not interference arising internally in its own wireless communication system, but radio wave interference with its own wireless communication system arising externally (outside the target wireless communication system). It should be noted that the radio wave interference source is not limited to a wireless communication system.

As illustrated in FIG. 1, the radio wave interference evaluation apparatus 100 is provided with an obtaining section 121 (obtaining means) and an evaluation section 122 (evaluation means).

The obtaining section 121 obtains a total received power in a predetermined frequency band measured at a point in a communication area of the target wireless communication system, a received power of a reference signal of the target wireless communication system measured at the point, and a status of radio resource usage of the target wireless communication system.

The total received power in the predetermined frequency band and the received power of the reference signal of the target wireless communication system are those measured by a terminal that is present at a point in the communication area of the target wireless communication system. This terminal may notify a core network of the target wireless communication system of each measured power via a base station. The obtaining section 121 is configured to obtain these pieces of information from the terminal or the core network.

The status of radio resource usage of the target wireless communication system is calculated in the core network of the target wireless communication system or in a base station constituting the target wireless communication system. The obtaining section 121 is configured to obtain, from the base station or the core network, the status of radio resource usage of the target wireless communication system.

The status of radio resource usage is not necessarily limited to actual information from the base station, but may be a value assumed in advance. For example, it is also possible to assume that the radio resource usage rate is 100% to make a conservative decision, and determine only radio wave interference with a great impact. The obtaining section 121 may obtain such an assumed value.

The total received power (RSSI) in the predetermined frequency band measured at a point in the communication area of the target wireless communication system includes: the sum of received power from a wireless communication system (target wireless communication system) with which a terminal located at a point in the communication area will communicate; and the sum of received power of radio waves transmitted from outside the target wireless system (e.g., another wireless communication system or a radio wave source other than wireless communication systems).

In short, RSSI can be expressed by the following relationship:

RSSI≈total received power (X) from target wireless communication system+total received power (Y) from outside target wireless communication system.

Here, the total received power (X) from the target wireless communication system can be estimated on the basis of the following two terms:
received power of a reference signal of the target wireless communication system; and
radio resource usage status of the target wireless communication system.

Therefore, by comparing the total received power (RSSI) and the estimated total received power (X′) from the target wireless communication system estimated from the received power of the reference signal of the target wireless communication system and the radio resource usage status of the target wireless communication system, it is possible to estimate the total received power (Y) from outside the target wireless communication system.

Thus, the evaluation section 122 evaluates radio wave interference with the target wireless communication system from outside the target wireless communication system, with reference to the total received power (RSSI) obtained by the obtaining section 121, the received power of the reference signal, and the status of radio resource usage.

Specifically, the evaluation section 122 estimates the estimated total received power (X′) from the target wireless communication system on the basis of the received power of the reference signal of the target wireless communication system and the radio resource usage status of the target wireless communication system.

Then, the evaluation section 122 compares the total received power (RSSI) obtained by the obtaining section 121 and the estimated total received power (X′) from the target wireless communication system. By this comparison, it is possible to infer the presence or absence of the total received power (Y) from outside the target wireless communication system expressed by the abovementioned relationship. Thus, for example, if Y is present, the evaluation section 122 can evaluate that the radio wave interference affecting the terminal at the point from outside the target wireless communication system is “present”.

Further, for example, the evaluation section 122 is capable of estimating the magnitude of the total received power (Y) from outside the target wireless communication system by comparing the RSSI and X′, and the strength of radio wave interference affecting the terminal at the point from outside the target wireless communication system may be evaluated.

As described in the foregoing, according to the radio wave interference evaluation apparatus 100, it is possible to evaluate radio wave interference from outside the target wireless communication system at the point in the communication area of the target wireless communication system by using the evaluation section 122.

### (Radio Wave Interference Evaluation Method)

The following description will discuss a radio wave interference evaluation method in accordance with the present example embodiment with reference to FIG. 2. FIG. 2 is a diagram illustrating the operation flow of the radio wave interference evaluation method in accordance with the present example embodiment. The operation flow illustrated in FIG. 2 is carried out by the radio wave interference evaluation apparatus 100 (computer) described above.

The radio wave interference evaluation method in accordance with the present example embodiment includes: obtaining, by the radio wave interference evaluation apparatus 100, a total received power in a predetermined frequency band measured at a point in a communication area of a target wireless communication system, a received power of a reference signal of the target wireless communication system measured at the point, and a status of radio resource usage of the target wireless communication system; and evaluating, by the radio wave interference evaluation apparatus 100, radio wave interference with the target wireless communication system from outside the target wireless communication system, with reference to the total received power, the received power of the reference signal, and the status of radio resource usage.

In detail, first, in step S1 (obtaining process), the obtaining section 121 obtains a total received power (RSSI) in a predetermined frequency band measured at a point in a communication area of a target wireless communication system, a received power of a reference signal of the target wireless communication system measured at the point, and a status of radio resource usage of the target wireless communication system. The total received power (RSSI), the received power of the reference signal, and the status of radio resource usage can be determined on the basis of information obtained from a terminal that is present at the point in the communication area of the target wireless communication system or a core network of the target wireless communication system.

In step S2 (evaluation process), the total received power (RSSI) in the predetermined frequency band and the received power of the reference signal, which are measured at the point in the communication area of the target wireless communication system, and the status of radio resource usage, all of which are obtained in step S1, are referred to. Then, in step S2, an estimated total received power (X′) from the target wireless communication system is estimated on the basis of the received power of the reference signal of the target wireless communication system and the radio resource usage status of the target wireless communication system. Then, the estimated total received power (X′) from the target wireless communication system is compared with the total received power (RSSI) in the predetermined frequency band.

In step S2, by this comparison, it is possible to infer the presence or absence of a total received power (Y) from outside the target wireless communication system, and it is also possible to evaluate the presence or absence of radio wave interference affecting the terminal at the point from outside the target wireless communication system.

In addition, in this step S2, it is also possible to estimate the magnitude of the total received power (Y) from outside the target wireless communication system by comparing the RSSI and X′, and it is also possible to evaluate the strength of radio wave interference affecting the terminal at the point from outside the target wireless communication system.

Thus, according to the radio wave interference evaluation method of the present example embodiment, it is possible to evaluate radio wave interference from outside the target wireless communication system at a point in the communication area of the target wireless communication system.

### (Radio Wave Interference Evaluation Program)

The above functions of the radio wave interference evaluation apparatus 100 may be implemented by a program. A radio wave interference evaluation program in accordance with the present example embodiment is a program for causing a computer to function as the radio wave interference evaluation apparatus, the program causing the computer to function as: obtaining means for obtaining a total received power in a predetermined frequency band measured at a point in a communication area of a target wireless communication system, a reference signal of the target wireless communication system measured at the point, and a received power of a status of radio resource usage of the target wireless communication system; and evaluation means for evaluating radio wave interference with the target wireless communication system from outside the target wireless communication system, with reference to the total received power, the received power of the reference signal, and the status of radio resource usage. Thus, according to the radio wave interference evaluation program in accordance with the present example embodiment, it is possible to achieve an example advantage of being capable of evaluating radio wave interference from outside the target wireless communication system at a point in the communication area of the target wireless communication system.

### Second Example Embodiment

The following description will discuss a second example embodiment of the present invention in detail with reference to the drawings. The same reference symbols are given to constituent elements which have functions identical to those described in the first example embodiment, and descriptions as to such constituent elements are omitted as appropriate.

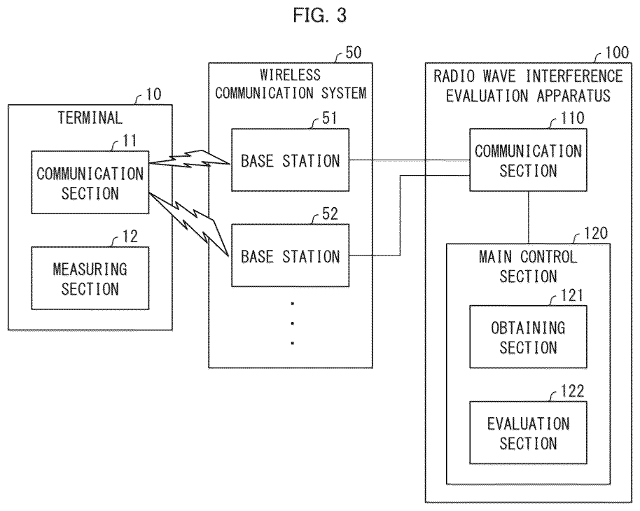

FIG. 3 is a block diagram illustrating the configuration of a radio wave interference evaluation apparatus 100 in accordance with the present example embodiment, the configuration of a wireless communication system 50 that is an evaluation target of the radio wave interference evaluation apparatus 100, and the configuration of a terminal 10 located within a communication area of the wireless communication system 50.

### (Terminal 10)

The terminal 10 is a wireless communication terminal that includes a communication section 11 and a measuring section 12.

When the terminal 10 is present within the communication area of the wireless communication system 50, the communication section 11 connects to a base station constituting the wireless communication system 50, to wirelessly communicate with the base station.

The measuring section 12 measures a total received power in a predetermined frequency band for use in communication and a received power of a reference signal from a target wireless communication system sent from the base station. The measured total received power in the predetermined frequency band and the measured received power of the reference signal are notified to the base station via the communication section 11.

In one example aspect, a received signal strength indicator (RSSI) can be used as the total received power. Further, a reference signal received power (RSRP) can be used as the received power of the reference signal.

### (Wireless Communication System 50)

The wireless communication system 50 is provided with multiple base stations 51, 52, and wirelessly communicates with the terminal 10.

Each base station 51, 52 is capable of communicating with a communication section 110 of the radio wave interference evaluation apparatus 100. Each base station 51, 52 provides the received power of the reference signal notified by the communication section 11 of the terminal 10 to the radio wave interference evaluation apparatus 100. Each base station 51, 52 provides its own radio resource usage status to the radio wave interference evaluation apparatus 100.

As a value indicating the radio resource usage status, a resource block usage rate, the number of resource blocks used, and the like may be used. The value indicating the radio resource usage status may be a value at a certain timing or may be an average value in a predetermined period.

### (Radio Wave Interference Evaluation Apparatus 100)

The radio wave interference evaluation apparatus 100 is provided with the communication section 110 and a main control section 120.

The communication section 110 is capable of communicating with each base station 51, 52 of the wireless communication system 50, and obtains information from each base station 51, 52. The communication section 110 may be capable of communicating with each base station 51, 52 of the wireless communication system 50 via a core network of the wireless communication system 50, or alternatively, the communication section 110 may be capable of performing communication directly.

The main control section 120 is provided with an obtaining section 121 (obtaining means) and an evaluation section 122 (evaluation means).

The obtaining section 121 obtains, for each base station 51, 52 constituting the wireless communication system 50 (target wireless communication system), the received power of the reference signal sent from the base station measured at a point in the communication area of the wireless communication system 50, and the radio resource usage status of the base station. The obtaining section 121 obtains these pieces of information via the communication section 110. As described above, the obtaining section 121 may obtain a value assumed in advance as the radio resource usage status.

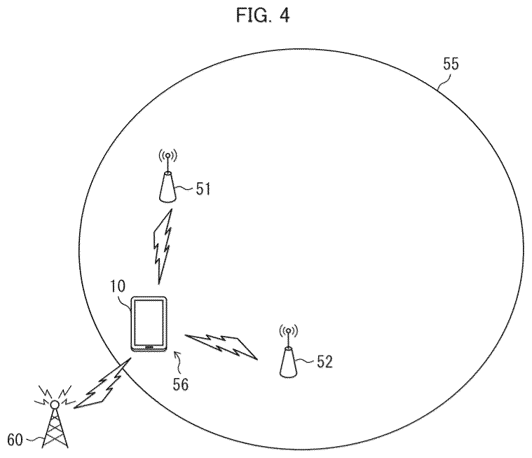

Here, FIG. 4 is a diagram illustrating a state in which the terminal 10 is located at point 56 in the communication area 55 of the wireless communication system 50. The terminal 10 located at point 56 is capable of communicating with the base station 51 and the base station 52, which constitute the wireless communication system 50.

The terminal 10 located at point 56 also receives a radio wave transmitted from a base station 60 of another wireless communication system different from the wireless communication system 50, and this causes radio wave interference. In short, the base station 60 is an interference source of radio wave interference with the wireless communication system 50 arising externally from outside the wireless communication system 50.

Since the terminal 10 located at the point 56 is affected by the radio wave interference caused by the base station 60, this might become a hindrance to perform the wireless communication within the communication area 55 (decrease in communication speed, delay in communication, etc.). The evaluation section 122 evaluates whether or not the terminal 10 is affected by radio wave interference caused by the base station 60 of the wireless communication system outside the wireless communication system 50 as illustrated in FIG. 4.

To evaluate the radio wave interference, the evaluation section 122 calculates an estimated total received power from the target wireless communication system at the point in the predetermined frequency band with reference to the received power of the reference signal and the radio resource usage status, and compares the estimated total received power and the total received power obtained by the obtaining section.

Here, “estimated total received power from the target wireless communication system at the point in the predetermined frequency band” refers to the total received power (X) from the target wireless communication system measured by the terminal 10 at the point 56 in the communication area 55 of the target wireless communication system.

In a case where multiple cells are present in the target wireless communication system, the total received power (X) from the target wireless communication system is the sum of a received power from each cell in the predetermined frequency band. In the following description, for simplicity, it is assumed that two cells, that is, cell A (cell of the base station 51) and cell B (cell of the base station 52) are present in the target wireless communication system.

In this assumption, the total received power (X) from the target wireless communication system can be expressed by the following relationship:

X=received power from cell A in predetermined frequency band+received power from cell B in predetermined frequency band.

An estimated received power from cell A in predetermined frequency band is obtained by multiplying the following two elements:
received power of reference signal of cell A; and
resource block usage rate or the number of resource blocks used of cell A.

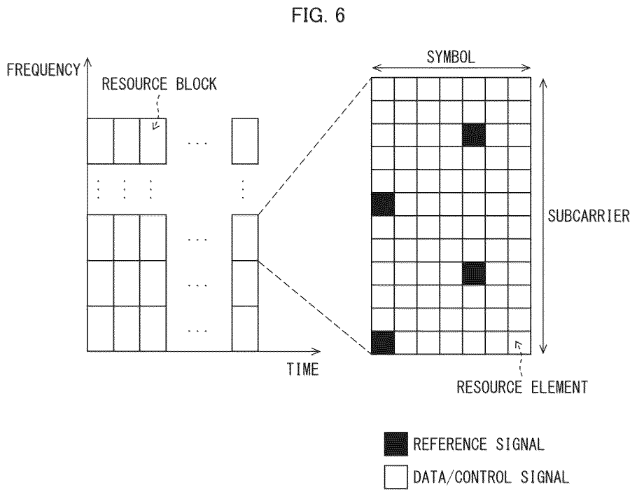

Here, these two elements will be described with reference to FIG. 6. As illustrated on the left side of FIG. 6, the wireless communication is performed using at least one of resource blocks (radio resources). As illustrated on the right side of FIG. 6, each resource block is constituted by multiple resource elements. The resource elements include a resource element which includes a reference signal and a resource element which includes data and a control signal.

Here, “received power of reference signal of cell A” refers to a received power of a reference signal illustrated in FIG. 6 measured by the terminal 10 (FIG. 3) that wirelessly communicates with cell A. Here, use of the “received power of reference signal” cannot take into account the traffic load including, for example, user data. Thus, to take into account the traffic load, the resource block usage rate or the number of used resources in the cell is used.

It should be noted that, in the present example embodiment, the estimated received power from cell A in the predetermined frequency band is obtained on the basis of the resource blocks, but the present invention is not limited thereto. Even in a case where the radio resource is not constituted by the resource blocks, it is possible to obtain the received power from cell A in predetermined frequency band if the received power were based on both the “received power of reference signal” and the radio resource usage status, which is an indicator of the traffic load including, for example, user data.

Further, the received power from cell B in the predetermined frequency band is also obtained by multiplying the received power of the reference signal of cell B by the resource block usage rate or the number of resource blocks used of cell B. Then, by adding the estimated received power from cell A in predetermined frequency band and the estimated received power from cell B in the predetermined frequency band, it is possible to calculate the estimated total received power in the predetermined frequency band.

It should be noted that, in a case where the terminal 10 is connected to an additional base station in addition to the base stations 51 and 52, it only needs to further add an estimated received power from a cell of the additional base station in the predetermined frequency band obtained by multiplying the received power of a reference signal of the cell by the resource block usage rate or the number of resource blocks used of the cell.

Next, the following description will discuss an example of calculation of the estimated total received power. Hereinbelow, an example in which the target wireless communication system is a long term evolution (LTE) system, which is a communication standard dedicated to mobile-type terminals. In a case of a communication system using LTE, it can be assumed that the transmission power is constant in all subcarriers. Therefore, the estimated total received power (X′) from the target wireless communication system can be estimated from the following equation.

$${X}^{′} = RSRP ( A ) \times RB ( A ) \times K + RSRP ( B ) \times RB ( B ) \times K$$

In this equation, RSRP(A) indicates the received power of the reference signal of cell A and RSRP(B) indicates the received power of the reference signal of cell B. Further, RB(A) indicates the resource block usage rate of cell A and RB(B) indicates the resource block usage rate of cell B. Further, K is a value obtained by multiplying the number of resource elements in the frequency direction in a resource block by the number of resource blocks in the frequency direction in the predetermined frequency band.

According to the above equation, it is possible to calculate the estimated total received power in the predetermined frequency band by multiplying the received power of the reference signal in one resource element by the number of resource elements in the frequency direction in the resource block, and by further multiplying the obtained product by the number of resource blocks in the frequency direction in the predetermined frequency band, and then by further multiplying the obtained product by the resource block usage rate.

It should be noted that even in a case where the target wireless communication system is a system for a communication standard dedicated to mobile-type terminals other than LTE, such as 5G/new radio (NR), or another wireless communication system that uses a reference signal, it is possible to calculate the estimated received power in the predetermined frequency band, considering the received power of the reference signal and the radio resource usage status, similarly to the case of using LTE.

In this way, the evaluation section 122 calculates the estimated total received power (X′) from the target wireless communication system.

As described in the first example embodiment, the evaluation section 122 compares the RSSI obtained by the obtaining section 121, that is, the total received power in the predetermined frequency band measured at point 56 in the communication area 55 of the target wireless communication system, with the calculated X′. As described above, the RSSI can be expressed by the following relationship:

RSSI≈total received power (X) from target wireless communication system+total received power (Y) from outside target wireless communication system.

Thus, by comparing the RSSI and the calculated X′, the evaluation section 122 evaluates the presence or absence of the total received power (Y) from outside the target wireless communication system.

To perform evaluation with higher accuracy, the evaluation section 122 may evaluate radio wave interference by comparing the total received power (RSSI) obtained by subtraction of background noise in a predetermined frequency band, with the estimated total received power (X′). The background noise includes artificial noises caused due to the contribution of an unspecified number of unintentional radiations, and natural noises. The characteristics of these noises greatly affect the communication quality of the wireless communication system. Thus, in evaluation of radio wave interference, it is possible to perform a high quality evaluation under a state in which the background noise is excluded. The evaluation section 122 may calculate background noise or obtain background noise externally, by known methods.

### (Radio Wave Interference Evaluation Method)

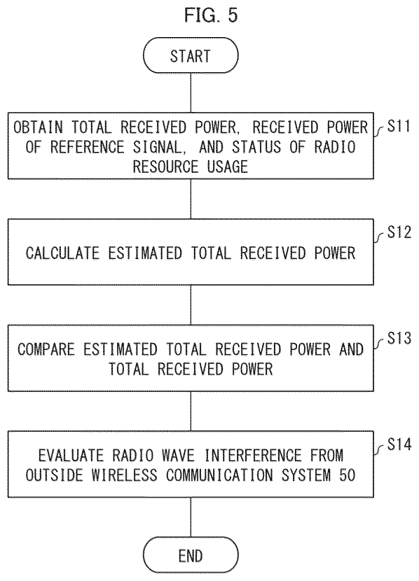

The following description will discuss a radio wave interference evaluation method in accordance with the present example embodiment with reference to FIG. 5. FIG. 5 is a diagram illustrating the operation flow of the radio wave interference evaluation method in accordance with the present example embodiment. The operation flow illustrated in FIG. 5 is carried out by the radio wave interference evaluation apparatus 100 illustrated in FIG. 3. In other words, it can be said that the radio wave interference evaluation method in accordance with the present example embodiment is carried out by the main control section 120 (FIG. 3).

More specifically, in the radio wave interference evaluation method in accordance with the present example embodiment, in step S11 (obtaining process) illustrated in FIG. 5, the obtaining section 121 (FIG. 3) of the main control section 120 obtains a total received power in a predetermined frequency band measured at a point in the communication area of a target wireless communication system, a received power of a reference signal of the target wireless communication system measured at the point, and a status of radio resource usage of the target wireless communication system.

Next, in step S12 (evaluation process 1), the evaluation section 122 (FIG. 3) of the main control section 120 calculates an estimated total received power (X′) from the target wireless communication system as described above.

Next, in step S13 (evaluation process 2), the evaluation section 122 (FIG. 3) compares the estimated total received power (X′) from the target wireless communication system calculated in step S12 and the RSSI (total received power of the predetermined frequency band measured at point 56) obtained by the obtaining section 121.

Next, in step S14 (evaluation process 3), when the RSSI is greater than X′ according to the comparison result, it is evaluated that there is a total received power (Y) from outside the target wireless communication system. In step S14, when there is Y, the strength of interference may be evaluated based on the magnitude thereof.

According to the foregoing radio wave interference evaluation method of the present example embodiment, it is possible to evaluate the presence or absence of radio wave interference from outside the target wireless communication system at a point in the communication area of the target wireless communication system, and the strength of the radio wave interference.

### [Variations]

The present example embodiment is not limited to the configurations described above, but may take various configurations as long as it is configured so that the radio wave interference evaluation apparatus 100 obtains a total received power in a predetermined frequency band measured at point 56 in the communication area 55 of the wireless communication system 50, a received power of a reference signal of the wireless communication system 50 measured at point 56, and a status of radio resource usage of the wireless communication system 50, and evaluates radio wave interference with the target wireless communication system 50 from outside the target wireless communication system 50, with reference to the total received power, the received power of the reference signal, and the status of radio resource usage. Hereinbelow, a few variations other than the configuration illustrated in FIG. 3 will be described.

### [Variation 1]

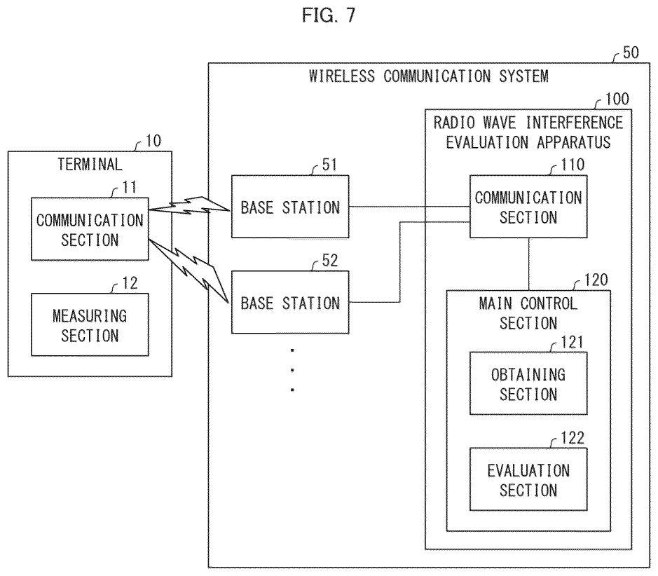

In the configuration illustrated in FIG. 3, the wireless communication system 50 and the radio wave interference evaluation apparatus 100 are separated from each other. That is, the radio wave interference evaluation is performed by a mechanism that is independent of the target wireless communication system. However, the present invention is not limited thereto, and a variation as illustrated in FIG. 7 may be employed.

FIG. 7 illustrates an example aspect in which the wireless communication system 50 includes the radio wave interference evaluation apparatus 100. As an example, the variation illustrated in FIG. 7 can be implemented by incorporating the radio wave interference evaluation apparatus 100 into a core network of the target wireless communication system. Even in the variation illustrated in FIG. 7, the operation flow of the radio wave interference evaluation is the same as that described in the present example embodiment.

### [Variation 2]

In the variation illustrated in FIG. 7, the wireless communication system 50 includes the radio wave interference evaluation apparatus 100; however, the present invention is not limited thereto, and the radio wave interference evaluation apparatus 100 may be included in a terminal.

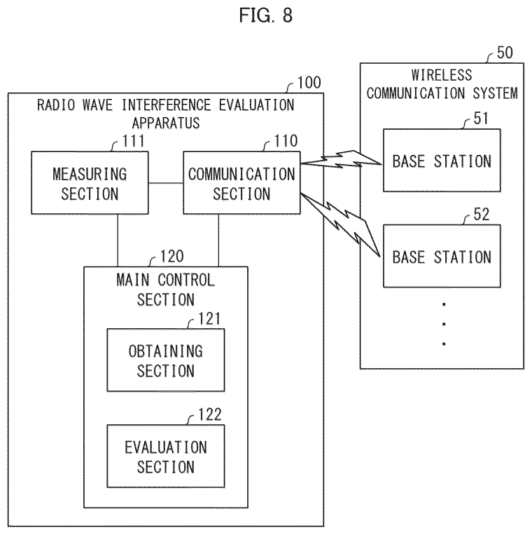

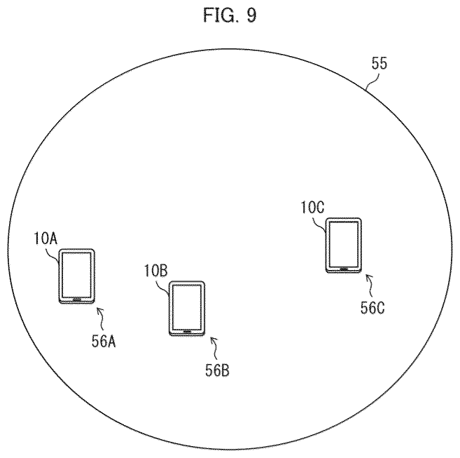

Specifically, as illustrated in FIG. 8, the radio wave interference evaluation apparatus 100 is provided with a communication section 110 that implements communication as a wireless communication terminal, a measuring section 111 that has the same functions as the measuring section 12 illustrated in FIG. 3, and a main control section 120. The main control section 120 has the same functions as the main control section 120 of FIG. 3 described in the present example embodiment. Even in the variation illustrated in FIG. 8, the operation flow of the radio wave interference evaluation is the same as that described in the present example embodiment.

### Third Example Embodiment

The following description will discuss a third example embodiment of the present invention in detail with reference to drawings. The same reference symbols are given to constituent elements which have functions identical to those described in the first and second example embodiments, and descriptions as to such constituent elements are omitted as appropriate.

In the second example embodiment described above, via each base station 51, 52, its own status of radio resource usage is provided to the radio wave interference evaluation apparatus 100. However, the present invention is not limited thereto, and a value assumed in advance may be used as the status of radio resource usage. For example, to make conservative decisions, it is possible to evaluate only radio wave interference with a great impact by assuming that the radio resource usage rate is 100%.

That is, the obtaining section 121 is not limited to the example aspect of the second example embodiment in which the radio resource usage status is directly obtained from each base station 51, 52.

As another example, the amount of traffic being transmitted to and received from a base station and the amount of buffering data at a base station may be obtained, and the radio resource usage status may be indirectly inferred on the basis of one or both of them.

According to the present example embodiment, the evaluation section 122 can estimate the received power from cell A in the predetermined frequency band on the basis of both the “received power of the reference signal” and the estimated radio resource usage status, and can calculate the estimated total received power (X′) from the target wireless communication system. Since the subsequent processes carried out by the evaluation section 122 are the same as those described in the second example embodiment, the description herein is omitted.

According to the foregoing radio wave interference evaluation apparatus of the present example embodiment, it is also possible to evaluate the presence or absence of radio wave interference from outside the target wireless communication system at a point in the communication area of the target wireless communication system, and the strength of the radio wave interference.

### Fourth Example Embodiment

The following description will discuss a fourth example embodiment of the present invention in detail with reference to the drawings. The same reference symbols are given to constituent elements which have functions identical to those described in the first and second example embodiments, and descriptions as to such constituent elements are omitted as appropriate.

In the second example embodiment described above, via each base station 51, 52, its own status of radio resource usage is provided to the radio wave interference evaluation apparatus 100. In the third example embodiment described above, the radio resource usage status is inferred. However, the present invention is not limited thereto, and the radio resource usage status may not be obtained or inferred, and instead, any control may be perform to achieve a desired radio resource usage status, and the evaluation section 122 may evaluate interference using the desired radio resource usage status.

As an example, excessive traffic may be intentionally generated. Intentionally generating excessive traffic results in a radio resource usage rate of 100% (desired radio resource usage status). By doing this, the evaluation section 122 (FIG. 3) evaluates the interference using the desired radio resource usage status. Generation of excessive traffic can be achieved by causing the main control section 120 (FIG. 3) to control the wireless communication system 50.

Thus, instead of obtaining or inferring the radio resource usage status, it is possible to evaluate interference by performing control to achieve the desired radio resource usage status.

### Fifth Example Embodiment

The following description will discuss a fifth example embodiment of the present invention in detail with reference to the drawings. The same reference symbols are given to constituent elements which have functions identical to those described in the first and second example embodiments, and descriptions as to such constituent elements are omitted as appropriate.

In the second example embodiment described above, as illustrated in FIG. 4, radio wave interference is evaluated on the basis of the total received power and the received power of the reference signal, which are measured by the terminal 10 at point 56. In contrast, as illustrated in FIG. 8, the present example embodiment differs in that the total received power and the received power of the reference signal measured by each of terminals 10A, 10B, and 10C located at points 56A, 56B, and 56C, respectively, are obtained, to evaluate radio wave interference for each point 56A, 56B, 56C.

Further, the present example embodiment differs from the second example embodiment described above in that the location of an interference source is inferred, in addition to identifying (evaluating) the presence or absence of radio wave interference.

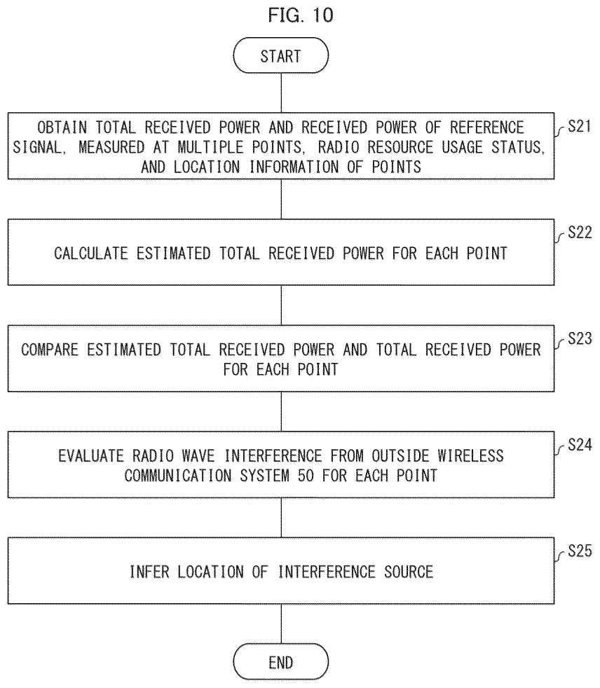

The following description will discuss the details with reference to the operation flow of the radio wave interference evaluation in accordance with the present example embodiment illustrated in FIG. 10. Since the configuration of the radio wave interference evaluation apparatus is the same as the radio wave interference evaluation apparatus 100 illustrated in FIG. 3, the description will be given with reference to the configuration of the radio wave interference evaluation apparatus 100 illustrated in FIG. 3.

An obtaining section 121 obtains the total received power (RSSI) and the received power of the reference signal measured by each of the terminals 10A, 10B, and 10C located at multiple points 56A, 56B, and 56C, respectively. The obtaining section 121 obtains, in addition to these, the status of usage of radio resource (resource blocks) and the location information of multiple points 56A, 56B, and 56C (step S21 in FIG. 10).

An evaluation section 122 evaluates radio wave interference for each point 56A, 56B, 56C. Specifically, an estimated total received power is calculated for each point 56A, 56B, 56C, on the basis of, for example, the total received power (RSSI) and the received power of the reference signal obtained by the obtaining section 121 (step S22 in FIG. 10). The estimated total received power is the estimated total received power (X′) from the target wireless communication system described in the second example embodiment. Since the calculation method is the same as that described in the second example embodiment, the description herein is omitted. It should be noted that, in the present example embodiment, the three points 56A, 56B, and 56C are illustrated as examples, and the number of points is not limited thereto.

Next, the evaluation section 122 compares the estimated total received power (X′) calculated for each point 56A, 56B, 56C in step S22 and the total received power (RSSI) (step S23 in FIG. 10).

Then, based on the comparison in step S23, the presence or absence of radio wave interference from outside the target wireless communication system 50 is evaluated for each point 56A, 56B, 56C (step S24 in FIG. 10). Since this evaluation is also the same as that described in the second example embodiment, the description herein is omitted.

It should be noted that the evaluation section 122 evaluates radio wave interference at each point 56A, 56B, 56C with reference to the total received power (RSSI) and the received power of the reference signal measured at each of the points 56A, 56B, and 56C in a single time slot, and the status of radio resource usage (e.g., resource block usage rate) of the target wireless communication system in the time slot, so as to suitably infer the location of an interference source in the subsequent steps.

Next, the evaluation section 122 infers the location of the interference source on the basis of the location information of points 56A, 56B, and 56C (step S25 in FIG. 10). Here, the location of the interference source includes an approximate location of which direction from each point the interference source is present, and the specific location of the interference source. The following description will discuss both the inference of the approximate location (direction) and the inference of the specific location.

### (Inference of Direction)

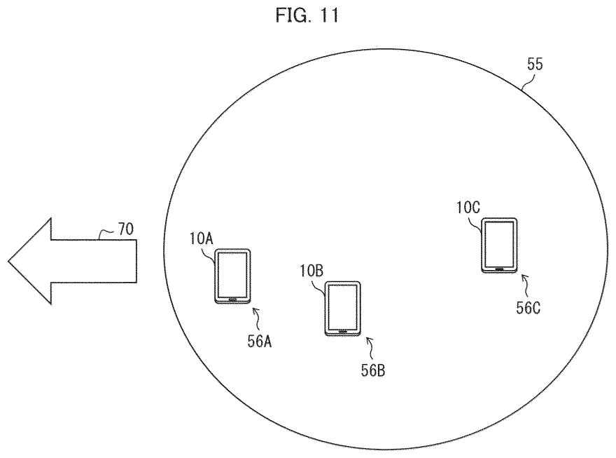

The location information of points 56A, 56B, and 56C is obtained by the terminals 10A, 10B, and 10C located at respective points 56A, 56B, and 56C. The evaluation section 122 maps the amounts of radio wave interference (strength of the radio wave interference) onto a map, using the location information of the points 56A, 56B, and 56C. FIG. 11 illustrated an example of mapping.

FIG. 11 illustrates an example in which the terminal 10A (point 56A) is affected by a greater radio wave interference amount, the terminal 10B (point 56B) is affected by a medium radio wave interference amount, and the terminal 10C (point 56C) is affected by no radio wave interference. By performing mapping on the map as illustrated in FIG. 11, it is possible to infer that an interference source is in a direction from the communication area 55 to the terminal 10A (point 56A), that is, in a direction indicated by an arrow 70.

### (Inference of Location)

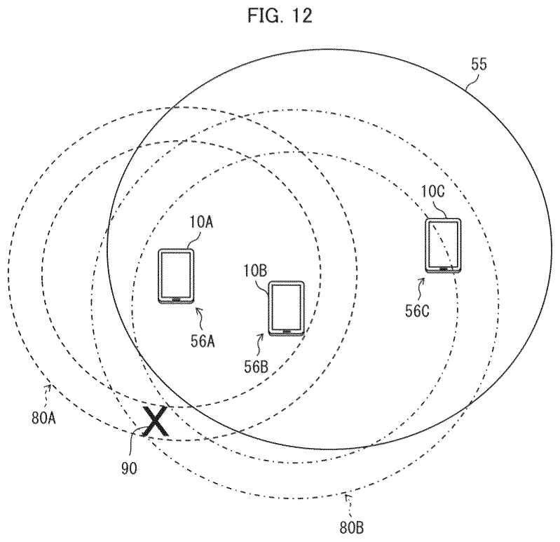

The evaluation section 122 is configured to identify, using the location information of points 56A, 56B, and 56C, an area from which an interference wave is supposed to be emitted, on the basis of the radio wave interference amount at each terminal 10A, 10B, 10C. The evaluation section 122 is also configured to map the area on the map. FIG. 12 illustrated an example of mapping.

FIG. 12 illustrates an example in which areas from which interference waves are emitted are mapped as circles (annuluses) 80A and 80B on the basis of the radio wave interference amounts at the terminals 10A and 10B, assuming the areas on the basis of the upper and lower limits of the radio output. Here, FIG. 12 illustrates a case in which the terminal 10C (point 56C) is not affected by any radio wave interference, as in the example of FIG. 11. The evaluation section 122 can identify a portion 90 where the mapped circles 80A and 80B illustrated in FIG. 12 overlap. This portion 90 can be an inferred location at which a radio wave interference source is present.

As described in the foregoing, according to the present example embodiment, the obtaining section 121 is configured to further obtain the location information of multiple points 56A, 56B, and 56C, and the evaluation section 122 is configured to infer the location of the interference source on the basis of the evaluation result of the radio wave interference at each of the points 56A, 56B, and 56C, and the location information of the points.

### Sixth Example Embodiment

The following description will discuss a sixth example embodiment of the present invention in detail with reference to the drawings. The same reference symbols are given to constituent elements which have functions identical to those described in the first, second, and third example embodiments, and descriptions as to such constituent elements are omitted as appropriate.

All of the above first through fifth example embodiments only carry out evaluation of radio wave interference. In contrast, the present example embodiment differs in further including a communication control section (control means) that controls or notifies at least one wireless communication system that is other than the target wireless communication system or a management apparatus that manages the at least one wireless communication system, on the basis of a result of a radio wave interference evaluation.

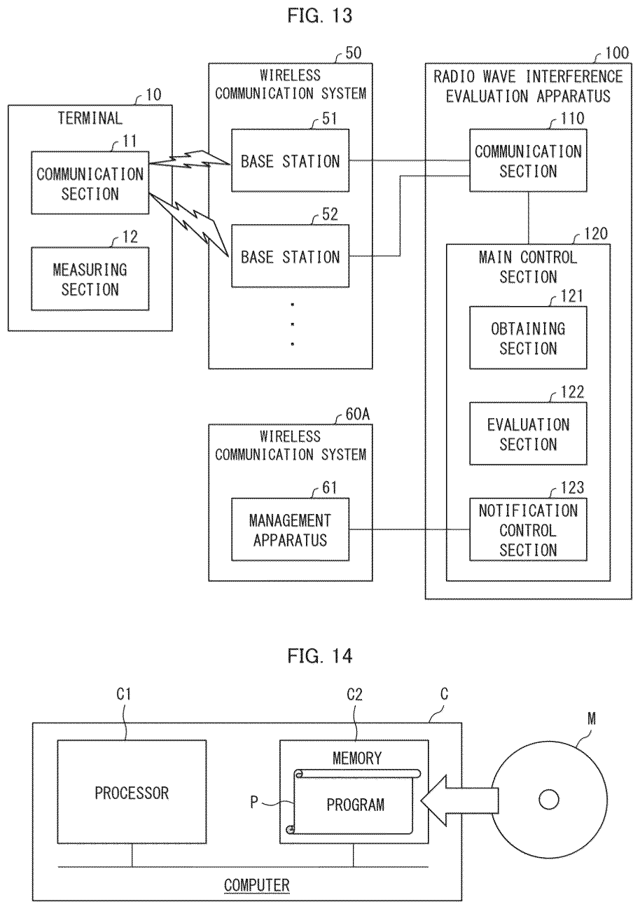

FIG. 13 is a block diagram illustrating the configuration of a radio wave interference evaluation apparatus 100 in accordance with the present example embodiment, and the main configurations of a target wireless communication system 50, a terminal 10 that wirelessly communicates with the target wireless communication system 50, and a wireless communication system 60A that is other than the target wireless communication system 50.

It is assumed that the communication area of the wireless communication system 60A is close to the communication area of the target wireless communication system 50 and that the wireless communication system 60A can be an interference source of radio wave interference affecting the target wireless communication system 50.

In the radio wave interference evaluation apparatus 100, a main control section 120 differs from the main control section 120 of the radio wave interference evaluation apparatus 100 illustrated in FIG. 3 in that it is provided with a notification control section 123 (control means). The notification control section 123 controls or notifies the wireless communication system 60A on the basis of a result of the evaluation obtained by the evaluation section 122. More specifically, the notification control section 123 may carry out control or notification to a management apparatus 61 that manages the wireless communication system 60A, or to another component of the wireless communication system 60A.

(Case where Notification is Made)

For example, when the evaluation result obtained by the evaluation section 122 indicates that interference is present, the notification control section 123 may notify the management apparatus 61 that radio wave interference has occurred in the wireless communication system 50. Further, for example, when the evaluation result obtained by the evaluation section 122 indicates the absence of interference, the notification control section 123 may notify the management apparatus 61 that no radio wave interference has occurred in the wireless communication system 50.

Here, in a case where the evaluation section 122 infers the location of an interference source as in the radio wave interference evaluation apparatus 100 in accordance with the fifth example embodiment, the notification control section 123 may select a notification destination on the basis of the location of the interference source inferred by the evaluation section 122. That is, the notification control section 123 may select the notification destination and carry out notification, on the basis of the location of the interference source inferred by the evaluation section 122, with reference to both a list of candidates of the notification destination and areas including locations corresponding to respective candidates included in the list.

(Case where Control is Performed)

A case where the notification control section 123 performs control of the management apparatus 61 is typically a case where the radio wave interference evaluation apparatus 100 is a third party independent of the wireless communication systems 50 and 60A, and manages both the wireless communication systems at a higher-level. In such a case, for example, when the evaluation result obtained by the evaluation section 122 indicates that interference is present, the notification control section 123 may control the management apparatus 61 to reduce or stop the output of the wireless communication system 60A.

Further, for example, in a state in which the output of the wireless communication system 60A has been reduced or stopped, the notification control section 123 may control the management apparatus 61 such that the output of the wireless communication system 60A returns to its original level when the evaluation result obtained by the evaluation section 122 indicates the absence of interference.

Similarly to the case where notification is made, in a case where the evaluation section 122 infers the location of the interference source as in the radio wave interference evaluation apparatus 100 in accordance with the fifth example embodiment, the notification control section 123 may select an object to be controlled on the basis of the location of the interference source inferred by the evaluation section 122. That is, the notification control section 123 may select the object to be controlled and perform control, on the basis of the location of the interference source inferred by the evaluation section 122, with reference to both a list of candidates to be controlled and areas including locations corresponding to respective candidates included in the list.

The notification control section 123 may perform both the notification and the control described above, or alternatively, may perform only one of them.

### [Software Implementation Example]

Some or all of functions of the radio wave interference evaluation apparatus can be realized by hardware such as an integrated circuit (IC chip) or can be alternatively realized by software.

In the latter case, the radio wave interference evaluation apparatus is realized by, for example, a computer that executes instructions of a program that is software realizing the functions. FIG. 14 illustrates an example of such a computer (hereinafter, referred to as “computer C”). The computer C includes at least one processor C1 and at least one memory C2. The memory C2 stores a program P for causing the computer C to operate as the radio wave interference evaluation apparatus. In the computer C, the processor C1 reads the program P from the memory C2 and executes the program P, so that the functions of the radio wave interference evaluation apparatus are realized.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a microcontroller, or a combination of these. The memory C2 can be, for example, a flash memory, a hard disk drive (HDD), a solid state drive (SSD), or a combination of these.

Note that the computer C can further include a random access memory (RAM) in which the program P is loaded when the program P is executed and in which various kinds of data are temporarily stored. The computer C may further include a communication interface via which data is transmitted to and received from another apparatus. The computer C can further include an input/output interface for connecting input-output apparatuses such as a keyboard, a mouse, a display and a printer.

The program P can be stored in a non-transitory tangible storage medium M which is readable by the computer C. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

### [Additional Remark 1]

The present invention is not limited to the above example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

Some of or all of the foregoing example embodiments can also be described as below. Note, however, that the present invention is not limited to the following supplementary notes.

### (Supplementary Note 1)

A radio wave interference evaluation apparatus including: obtaining means for obtaining a total received power in a predetermined frequency band measured at a point in a communication area of a target wireless communication system, a received power of a reference signal of the target wireless communication system measured at the point, and a status of radio resource usage of the target wireless communication system; and evaluation means for evaluating radio wave interference with the target wireless communication system from outside the target wireless communication system, with reference to the total received power, the received power of the reference signal, and the status of radio resource usage.

### (Supplementary Note 2)

The radio wave interference evaluation apparatus according to Supplementary note 1, wherein, for each base station constituting the target wireless communication system, the obtaining means obtains a received power of a reference signal sent from the base station measured at the point and a status of radio resource usage of the base station.

### (Supplementary Note 3)

The radio wave interference evaluation apparatus according to Supplementary note 1 or 2, wherein, to evaluate the radio wave interference, the evaluation means calculates an estimated total received power from the target wireless communication system at the point in the predetermined frequency band with reference to the received power of the reference signal and the status of radio resource usage, and compares the estimated total received power and the total received power obtained by the obtaining means.

### (Supplementary Note 4)

The radio wave interference evaluation apparatus according to Supplementary note 3, wherein, to evaluate the radio wave interference, the evaluation means compares the total received power and the estimated total received power, the total received power being obtained by subtraction of background noise in the predetermined frequency band.

### (Supplementary Note 5)

The radio wave interference evaluation apparatus according to any one of Supplementary notes 1 to 4, wherein
the obtaining means obtains the total received power and the received power of the reference signal at each of multiple points, and
the evaluation means evaluates the radio wave interference at each of the points.

### (Supplementary Note 6)

The radio wave interference evaluation apparatus according to Supplementary note 5, wherein
the obtaining means further obtains location information of the points, and
the evaluation means infers a location of an interference source of the radio wave interference based on a result of the evaluation of the radio wave interference at each of the points and the location information of the points.

### (Supplementary Note 7)

The radio wave interference evaluation apparatus according to Supplementary note 5 or 6, wherein the evaluation means evaluates the radio wave interference at each of the points, with reference to the total received power and the received power of the reference signal measured at each of the points in a single time slot.

### (Supplementary Note 8)

The radio wave interference evaluation apparatus according to any one of Supplementary notes 1 to 7, further including control means for controlling or notifying at least one wireless communication system that is other than the target wireless communication system or a management apparatus that manages the at least one wireless communication system, based on a result of the evaluation of the radio wave interference obtained by the evaluation means.

### (Supplementary Note 9)

A radio wave interference evaluation method including: obtaining, by a computer, a total received power in a predetermined frequency band measured at a point in a communication area of a target wireless communication system, a received power of a reference signal of the target wireless communication system measured at the point, and a status of radio resource usage of the target wireless communication system; and evaluating, by the computer, radio wave interference with the target wireless communication system from outside the target wireless communication system, with reference to the total received power, the received power of the reference signal, and the status of radio resource usage.

### (Supplementary Note 10)

A radio wave interference evaluation program for causing a computer to function as a radio wave interference evaluation apparatus, the program causing the computer to function as: obtaining means for obtaining a total received power in a predetermined frequency band measured at a point in a communication area of a target wireless communication system, a received power of a reference signal of the target wireless communication system measured at the point, and a status of radio resource usage of the target wireless communication system; and evaluation means for evaluating radio wave interference with the target wireless communication system from outside the target wireless communication system, with reference to the total received power, the received power of the reference signal, and the status of radio resource usage.

### [Supplementary Note 11]

Furthermore, some of or all of the above example embodiments can also be expressed as below.

A radio wave interference evaluation apparatus including at least one processor, the at least one processor carrying out: an obtaining process of obtaining a total received power in a predetermined frequency band measured at a point in a communication area of a target wireless communication system, a received power of a reference signal of the target wireless communication system measured at the point, and a status of radio resource usage of the target wireless communication system; and an evaluation process of evaluating radio wave interference with the target wireless communication system from outside the target wireless communication system, with reference to the total received power, the received power of the reference signal, and the status of radio resource usage.

Note that the radio wave interference evaluation apparatus may further include a memory, which may store therein a program for causing the at least one processor to carry out the obtaining process and the evaluation process. Alternatively, the program may be stored in a computer-readable, non-transitory, tangible storage medium.

### REFERENCE SIGNS LIST

10, 10A, 10B, 10C Terminals
11, 110 Communication section
12, 111 Measuring section
50 Wireless communication system (target wireless communication system)
51, 52 Base stations
55 Communication area
56, 56A, 56B, 56C Points
60A Wireless communication system other than target wireless communication system
61 Management apparatus
80A, 80B Areas including radio wave interference source
100 Radio wave interference evaluation apparatus
120 Main control section
121 Obtaining section
122 Evaluation section
123 Notification control section

What is claimed is:

1. A radio wave interference evaluation apparatus comprising at least one processor, the at least one processor carrying out:
an obtaining process of obtaining a total received power in a predetermined frequency band measured at a point in a communication area of a target wireless communication system, a received power of a reference signal of the target wireless communication system measured at the point, and a status of radio resource usage of the target wireless communication system; and
an evaluation process of evaluating radio wave interference with the target wireless communication system from outside the target wireless communication system, with reference to the total received power, the received power of the reference signal, and the status of radio resource usage.

2. The radio wave interference evaluation apparatus according to claim 1, wherein, for each base station constituting the target wireless communication system, in the obtaining process, the at least one processor obtains a received power of a reference signal sent from the base station measured at the point and a status of radio resource usage of the base station.

3. The radio wave interference evaluation apparatus according to claim 1, wherein, to evaluate the radio wave interference, in the evaluation process, the at least one processor calculates an estimated total received power from the target wireless communication system at the point in the predetermined frequency band with reference to the received power of the reference signal and the status of radio resource usage, and compares the estimated total received power and the total received power obtained in the obtaining process.

4. The radio wave interference evaluation apparatus according to claim 3, wherein, to evaluate the radio wave interference, in the evaluation process, the at least one processor compares the total received power and the estimated total received power, the total received power being obtained by subtraction of background noise in the predetermined frequency band.

5. The radio wave interference evaluation apparatus according to claim 1, wherein
in the obtaining process, the at least one processor obtains the total received power and the received power of the reference signal at each of multiple points, and
in the evaluation process, the at least one processor evaluates the radio wave interference at each of the points.

6. The radio wave interference evaluation apparatus according to claim 5, wherein
the obtaining means further obtains location information of the points, and
the evaluation means infers a location of an interference source of the radio wave interference based on a result of the evaluation of the radio wave interference at each of the points and the location information of the points.

7. The radio wave interference evaluation apparatus according to claim 5, wherein in the evaluation process, the at least one processor evaluates the radio wave interference at each of the points, with reference to the total received power and the received power of the reference signal measured at each of the points in a single time slot.

8. The radio wave interference evaluation apparatus according to claim 1, wherein the at least one processor further carries out a control process of controlling or notifying at least one wireless communication system that is other than the target wireless communication system or a management apparatus that manages the at least one wireless communication system, based on a result of the evaluation of the radio wave interference obtained in the evaluation process.

9. A radio wave interference evaluation method comprising:
obtaining, by a computer, a total received power in a predetermined frequency band measured at a point in a communication area of a target wireless communication system, a received power of a reference signal of the target wireless communication system measured at the point, and a status of radio resource usage of the target wireless communication system; and
evaluating, by the computer, radio wave interference with the target wireless communication system from outside the target wireless communication system, with reference to the total received power, the received power of the reference signal, and the status of radio resource usage.

10. A non-transitory storage medium storing a radio wave interference evaluation program for causing a computer to function as a radio wave interference evaluation apparatus, the radio wave interference evaluation program causing the computer to carry out:
an obtaining process of obtaining a total received power in a predetermined frequency band measured at a point in a communication area of a target wireless communication system, a received power of a reference signal of the target wireless communication system measured at the point, and a status of radio resource usage of the target wireless communication system; and
an evaluation process of evaluating radio wave interference with the target wireless communication system from outside the target wireless communication system, with reference to the total received power, the received power of the reference signal, and the status of radio resource usage.
